(19) United States
(12) Patent Application Publication
(10) Pub. No.: US 2007/0036028 A1
(43) Pub. Date: Feb. 15, 2007

(54) Agitator and agitating device with agitator

(75) Inventor: Hisao Yoshioka, Kawaguchi-shi (JP)

Correspondence Address: FASSE PATENT ATTORNEYS, P.A., P.O. BOX 726, HAMPDEN, ME, 04444-0726, US

(73) Assignee: AICOHSHA MFG. CO., LTD., Warabi-shi (JP)

(21) Appl. No.: 10/573,370

(22) PCT Filed: Sep. 22, 2004
(86) PCT No.: PCT/JP04/13794

§ 371 Date: Mar. 24, 2006

(30) Foreign Application Priority Data
Sep. 26, 2003 (JP) 2003-336576

(51) Int. Cl. B01F 7/32

(52) U.S. Cl. 366/312; 366/325.7

(57) ABSTRACT

To provide an agitator which allows easy disassembly and reassembly thereof and washing of every component separately, thus securing satisfactory workability and in turn safety of foods and quality stability of chemicals, and moreover effectively preventing the entrained rotation of the material to enhance the agitating effect. The agitator comprises at least three biased agitating blades arranged to contact a virtual sphere centered on a virtual central axis extending vertically and surround the central axis, wherein each of the biased agitating blades is provided with a penetrating window, one end in the circumferential direction of the central axis of each biased agitating blade rests on an inner face facing the central axis of an adjoining biased agitating blade on said one side in the circumferential direction of the central axis, the other end thereof in the circumferential direction of the central axis protrudes to back away from the central axis than an adjoining agitating blade on the other side in the circumferential direction of the central axis, and the adjoining agitating blades are separably connected to each other.

### TECHNICAL FIELD

The present invention relates to an agitator which is set within a vessel, is attachably and detachably mounted on a supporting member extending downward on an agitating device, makes rotation and/or revolution in relation to the vessel due to rotation of at least either the supporting member or the vessel to agitate a material in the vessel, and an agitating device on which the agitator is mounted.

### BACKGROUND ART

Agitators of this kind include those of relatively simple forms, such as one made by bending a single bar-like member into a key form or one comprised of a single plate member. On the other hand, there are agitators of complicated forms, for example, patent document 1 discloses a cage-shaped agitator wherein linear members are bent into substantially U-shaped forms and a large number of these linear members are assembled into a cage form.

Some agitators are provided with agitating blades. Patent document 2 discloses an agitator having disc turbine blades, which is an agitator provided for a large-sized agitating vessel of a different-phase system reactor. Such an agitator promotes agitating by making a material flow outwardly in the radial directions. Moreover, patent document 3 discloses an agitator having tilted paddle blades, which is an agitator to be set at the center of an agitating vessel. Such an agitator promotes agitating by making a material circulate in the vertical direction. Patent document 4 discloses lattice blades comprising vertical members and cross members as an agitator to be set at the center of an agitating vessel.

Patent document 1: Patent Publication (Unexamined) No. 2000-342951

Patent document 2: Patent Publication (Unexamined) No. 2003-164747

Patent document 3: Patent Publication (Unexamined) No. 2002-3445

Patent document 4: Patent Publication (Unexamined) No. Heisei 9-108557

### DISCLOSURE OF INVENTION

When, for example, a food is to be agitated by an agitating device, it is necessary to prevent growth of bacteria in the food and contamination of the food by foreign matter so as to ensure safety of the food. Furthermore, when, for example, a chemical is to be agitated by an agitating device, it is necessary to prevent degeneration of the chemical and contamination of the chemical by foreign matter so as to ensure stable quality of the chemical. To this end, it is required after use to dismount the agitator from the supporting member and wash the agitator. However, in the case of an agitator of a complicated form, it is difficult to completely eliminate the material such as food or chemical which penetrated into narrow gaps of members constituting the agitator. In particular, this problem is conspicuous in the case of the cage-shaped agitator which was exemplified by patent document 1.

When a material in a vessel is agitated by making an agitator rotate and/or revolve in relation to the vessel, although depending on the physical properties such as viscosity of the material, the speed of rotation of the agitator and other factors, the material might be forced to the vicinity of the agitator by the centrifugal forces, become a tubular mass and be rotated together with the agitating blades, preventing effective agitating. In the cases of the agitating device having disc turbine blades, the agitating device having tilted paddle blades and the agitating device having lattice blades mentioned above, it is difficult to effectively prevent this entrained rotation of the material on the axis of rotation and/or the axis of revolution (hereinafter simply referred to as the entrained rotation of the material).

The present inventor repeated a variety of experiments and has successfully solved these problems. One object of the present invention is to provide an agitator which allows easy disassembly and reassembly thereof and washing of every component separately, thus securing satisfactory workability and in turn safety of foods and quality stability of chemicals, and moreover effectively preventing the entrained rotation of the material to enhance the agitating effect.

To accomplish said object, the agitator of the present invention is an agitator which is set within a vessel having a bottom and a circumferential wall rising from the circumference of the bottom, is attachably and detachably mounted on a supporting member extending downward on an agitating device, makes rotation and/or revolution in relation to the vessel due to rotation of at least either the supporting member or the vessel to agitate a material in the vessel. This agitator comprises at least three biased agitating blades arranged to contact a virtual sphere centered on a virtual central axis extending vertically and surround the central axis, wherein each of the biased agitating blades is provided with a penetrating window, one end in the circumferential direction of the central axis of each biased agitating blade rests on an inner face facing the central axis of an adjoining biased agitating blade on said one side in the circumferential direction of the central axis, the other end thereof in the circumferential direction of the central axis protrudes to back away from the central axis than an adjoining agitating blade on the other side in the circumferential direction of the central axis, and the adjoining agitating blades are separably connected to each other.

As this agitator is comprised of the biased agitating blades and the adjoining biased agitating blades are separably connected to each other, the agitator can be disassembled after every use and the respective components thereof can be washed and dried and then reassembled, and these operations are easy. And, for example, when a food is to be agitated, the use of this agitator prevents growth of bacteria in the food and contamination of the food by foreign matter, thus the safety of the food is secured. Moreover, for example, when a chemical is to be agitated, the use of this agitator prevents degeneration of the chemical and contamination thereof by foreign matter, thus the stability of the quality of the chemical is secured.

At least three biased agitating blades are provided in such a way that they contact a virtual sphere and surround the central axis, each biased agitating blade is provided with a penetrating window, and each biased agitating blade is so arranged that one end in the circumferential direction of the central axis of each biased agitating blade rests on an inner face facing the central axis of an adjoining biased agitating blade on said one side in the circumferential direction of the central axis, and the other end thereof in the circumferential direction of the central axis protrudes to back away from the central axis than an adjoining agitating blade on the other side in the circumferential direction of the central axis. Hence the entrained rotation of the material is effectively prevented. The causes of this are estimated that as each biased agitating blade does not extend in any radial direction of the central axis but extends off the central axis to surround the central axis, the flows of the material in the circumferential direction of the central axis are divided into flows of the material along the biased agitating blades and flows of the material passing the windows of the biased agitating blades, which results in complex flows of the material, and that the end of each biased agitating blade protruding from an adjoining biased agitating blade induces disturbances in the flows of the material. Moreover, when the material passes through the window of each biased agitating blade, the material is subjected to shearing forces and in turn the agitating is enhanced and foaming due to air mixing is enhanced as well.

It will be appreciated that the present invention successfully provides an agitator which allows easy disassembly and reassembly thereof and washing of every component separately, thus securing satisfactory workability and in turn safety of foods and quality stability of chemicals, and moreover effectively preventing the entrained rotation of the material to enhance the agitating effect.

The agitator of the present invention may be so arranged that, in said agitator, in place of so arranging at least three biased agitating blades that the blades contact a virtual sphere centered on a virtual central axis extending vertically and surround the central axis, at least three biased agitating blades contact the circumferential face of a virtual cylinder of which central axis is coincident with a virtual central axis extending vertically and surround the central axis.

With this arrangement, the circulation of the material in the vertical direction is suppressed, and the design and production of the biased agitating blades are relatively easy.

The agitator of the present invention may be said agitator wherein the agitator is provided with a connecting member, which is detachably and attachably mounted on the supporting member of the agitating device, and the biased agitating blades are separably connected to the connecting member.

With this arrangement, as the biased agitating blades are held by the connecting member as well, the mounting strength of the biased agitating blades is enhanced.

The agitator of the present invention may be said agitator wherein the agitator is provided, in the lower part or on the lower side thereof, with plate-type radial agitating blades, of which end edges are substantially aligned with the central axis and which extend in radial directions of the central axis and are provided with penetrating windows, and the radial agitating blades are separably connected to the biased agitating blades.

With this arrangement, when a vessel of which horizontal section is reduced in its lower part is used, the material present in a position that can not be agitated by the biased agitating blades is agitated by the radial agitating blades.

The agitator of the present invention may be said agitator wherein the spacing between the frames of each window of the biased agitating blades is greater than the spacing between the frames of each window of the radial agitating blades.

With this arrangement, when the material foaming due to air mixing rises, the probability of collapsing this foaming is lower.

The agitator of the present invention may be provided, on at least either the biased agitating blades or the radial agitating blades, with a coil spring compressively mounted between window frames.

With this arrangement, when the material passes the coil spring, the material is subjected to shearing forces to promote the agitating, and foaming due to air mixing is also enhanced. The coil spring can be mounted in or dismounted from the windows easily by compressing the coil spring, and the degree of foaming is adjusted by mounting or dismounting the coil spring. Moreover, the working of the coil spring is adjusted by changing the diameter, pitch, etc. of the wire of the coil spring.

Accordingly, the agitating state due to shearing forces and the foaming state due to air mixing can be easily adjusted by selecting mounting or dismounting of the coil springs, setting of the wire diameter, wire pitch, etc.

The agitating device with agitator of the present invention comprises an agitating device having a supporting member extending downward, a vessel having a bottom and a circumferential wall rising from the circumference of the bottom, said vessel being mounted on the agitating device, and said agitator of the present invention being attachably and detachably mounted on the supporting member of the agitating device, wherein the agitator is made to rotate and/or revolve in relation to the vessel due to rotation of at least either the supporting member or the vessel so as to agitate a material in the vessel.

It will be appreciated that this successfully provides an agitating device with agitator, which exhibits the effect obtained by said agitator of the present invention.

The agitating device with agitator of the present invention comprises an agitating device having a plurality of supporting members extending downward, said supporting members having their rotation axes or revolution axes kept substantially parallel, a vessel having a bottom and a circumferential wall rising from the circumference of the bottom, said vessel being mounted on the agitating device, and a plurality of said agitators of the present invention being attachably and detachably mounted respectively on the supporting members of the agitating device, wherein the agitators are made to rotate and/or revolve in relation to the vessel due to rotation of at least either the supporting members or the vessel so as to agitate a material in the vessel.

It will be appreciated that this successfully provides a multi-axial agitating device with agitator, which exhibits the effect obtained by said agitator of the present invention.

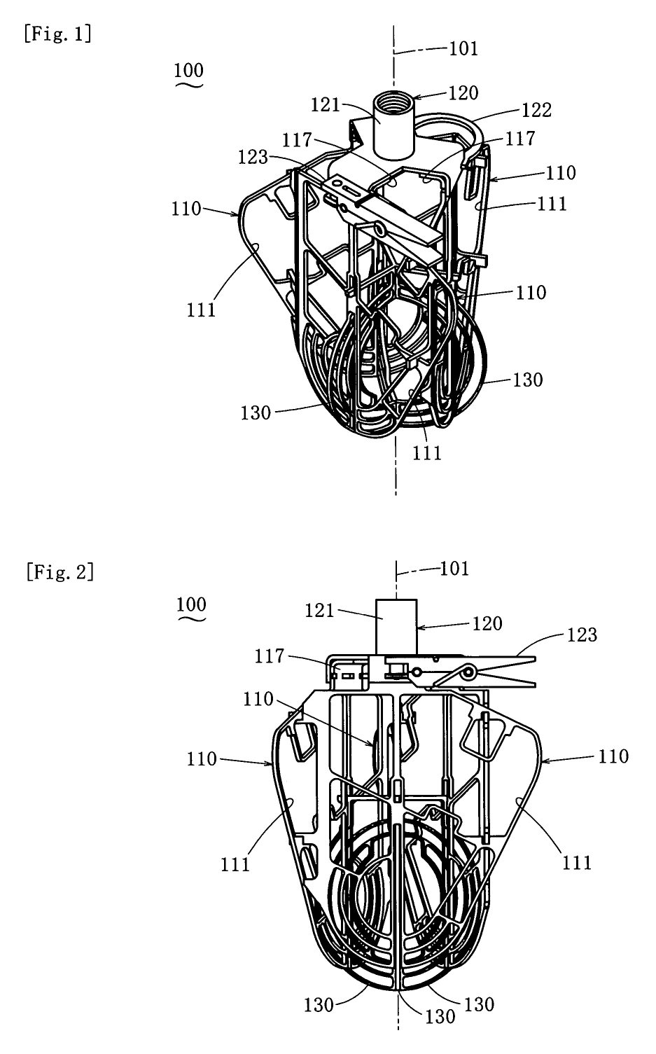

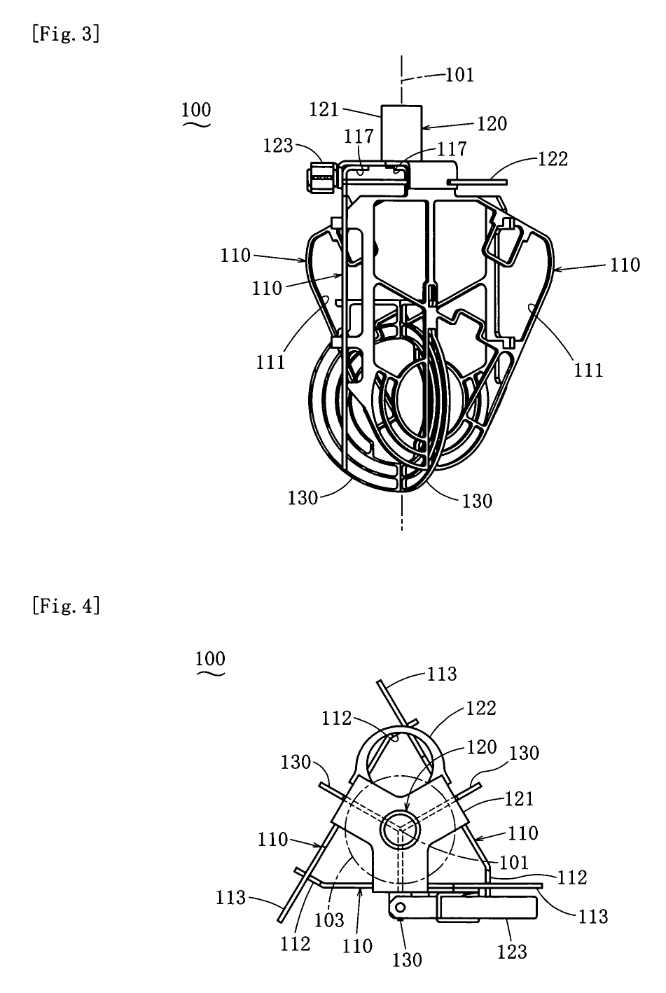

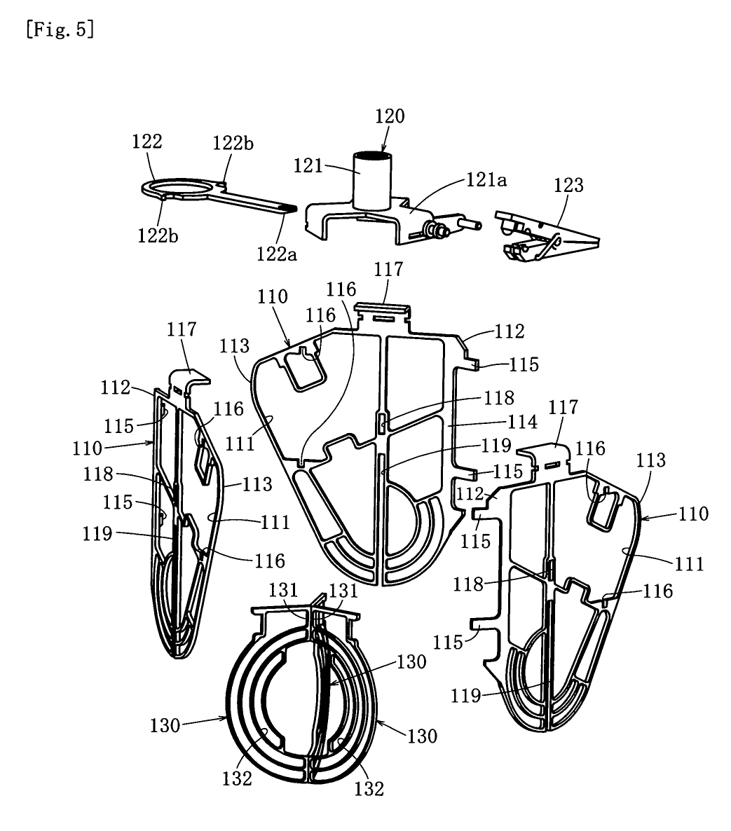

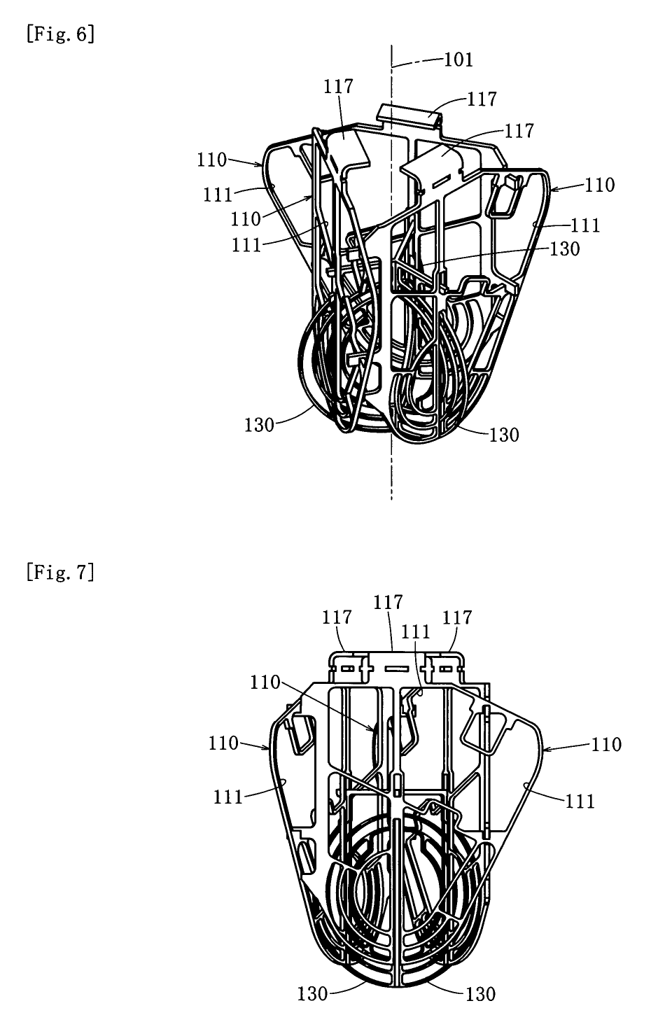

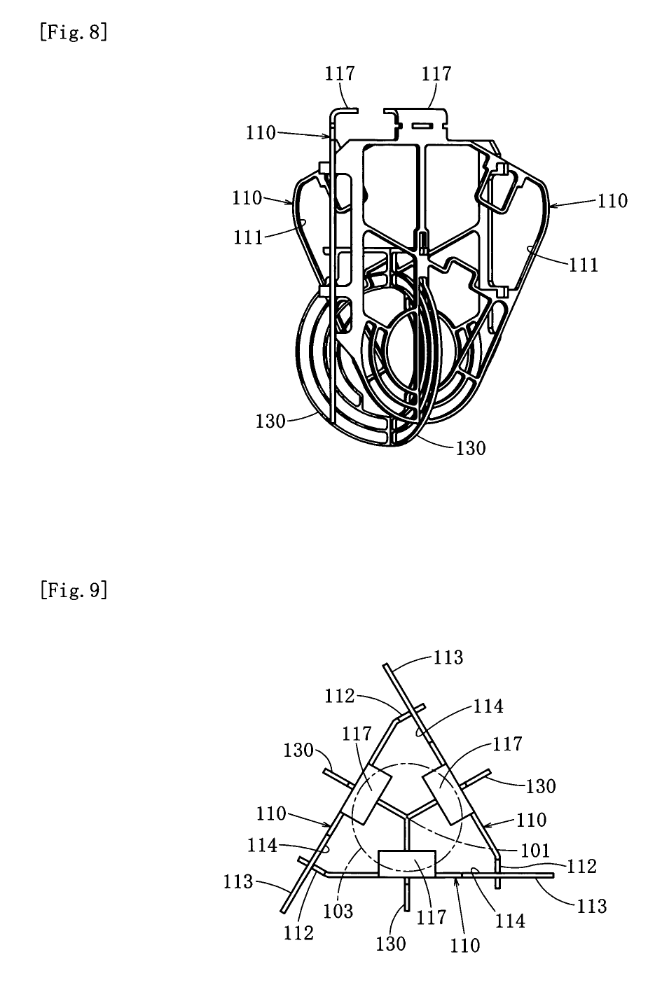

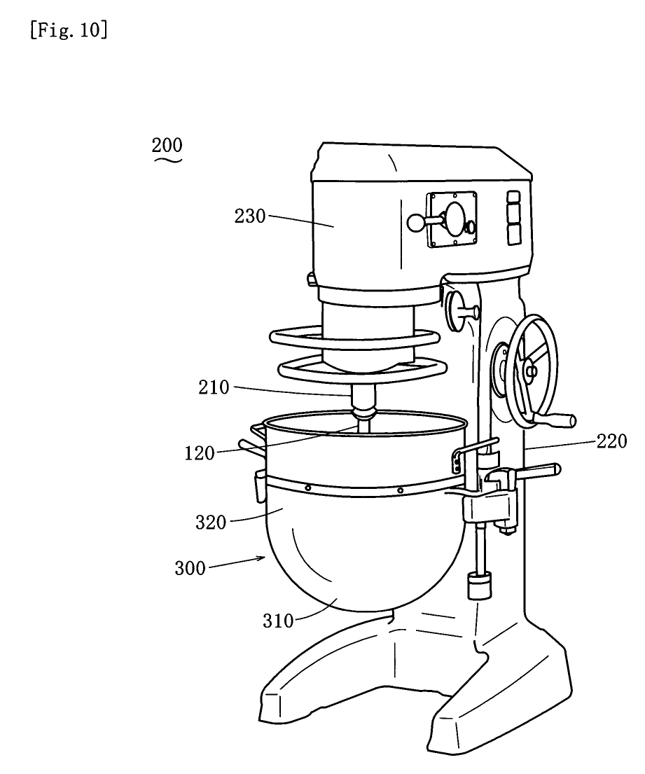

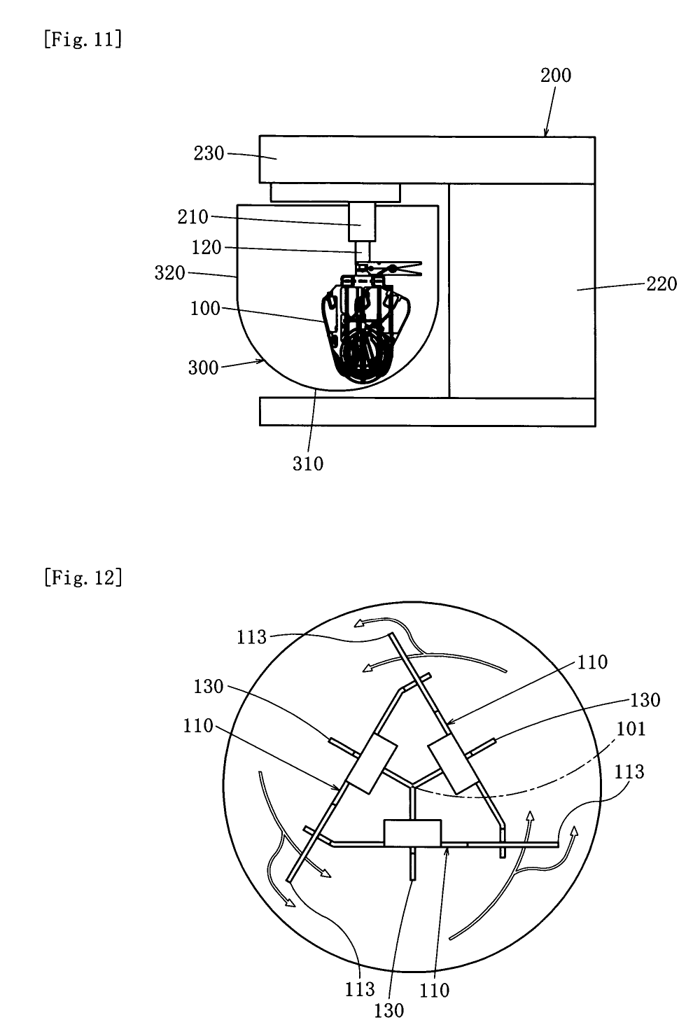

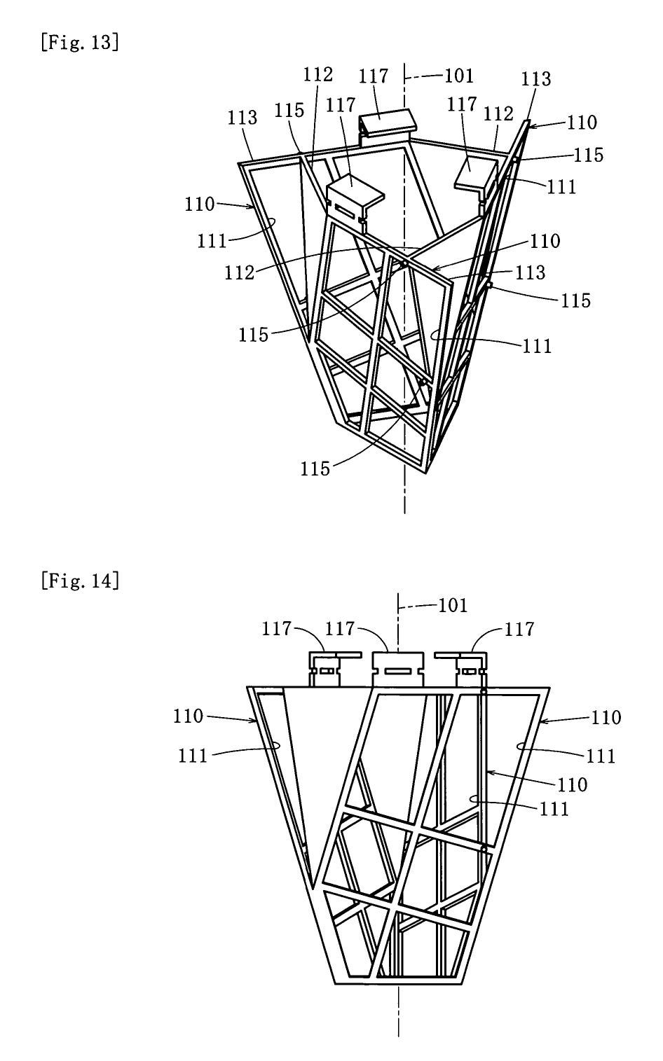

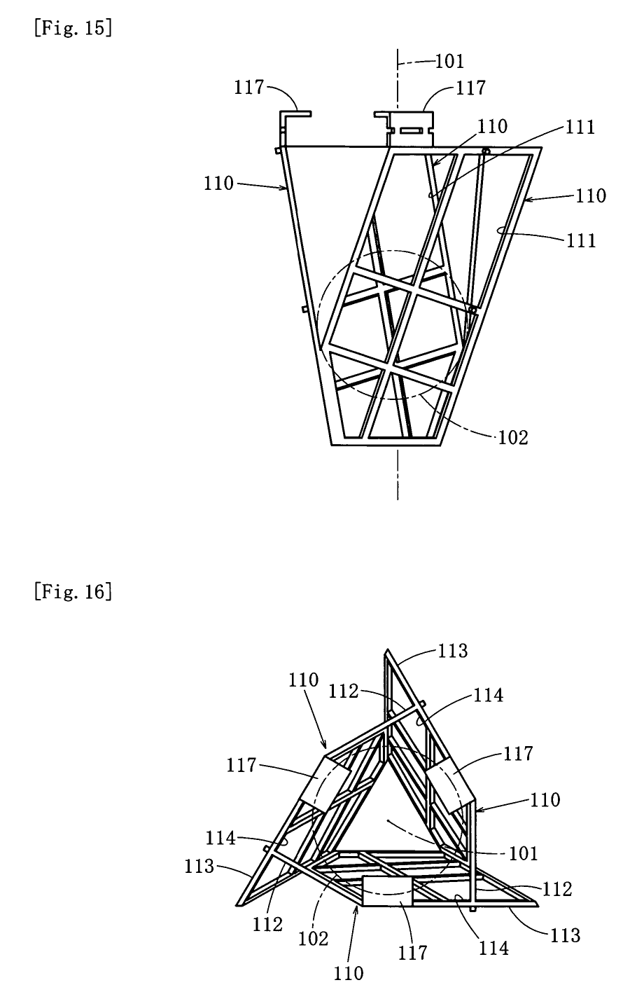

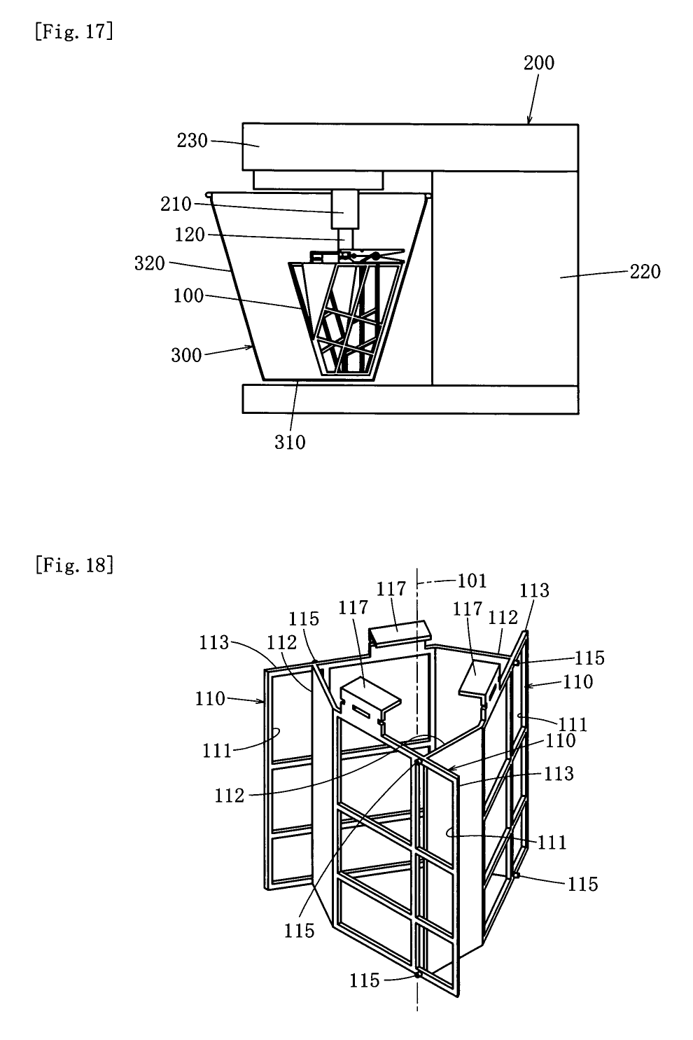

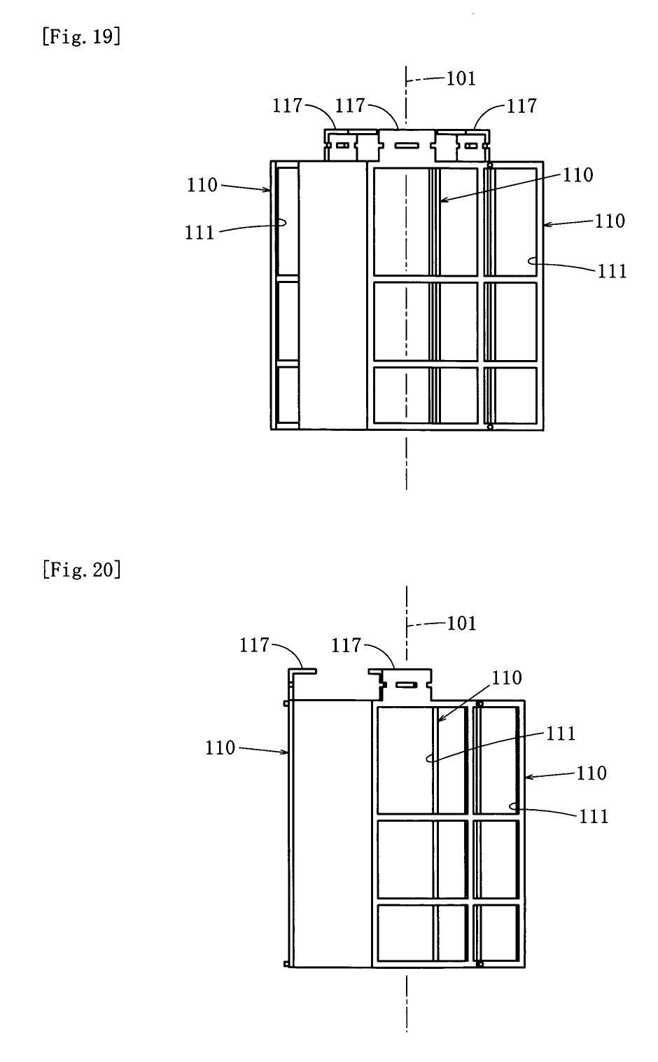

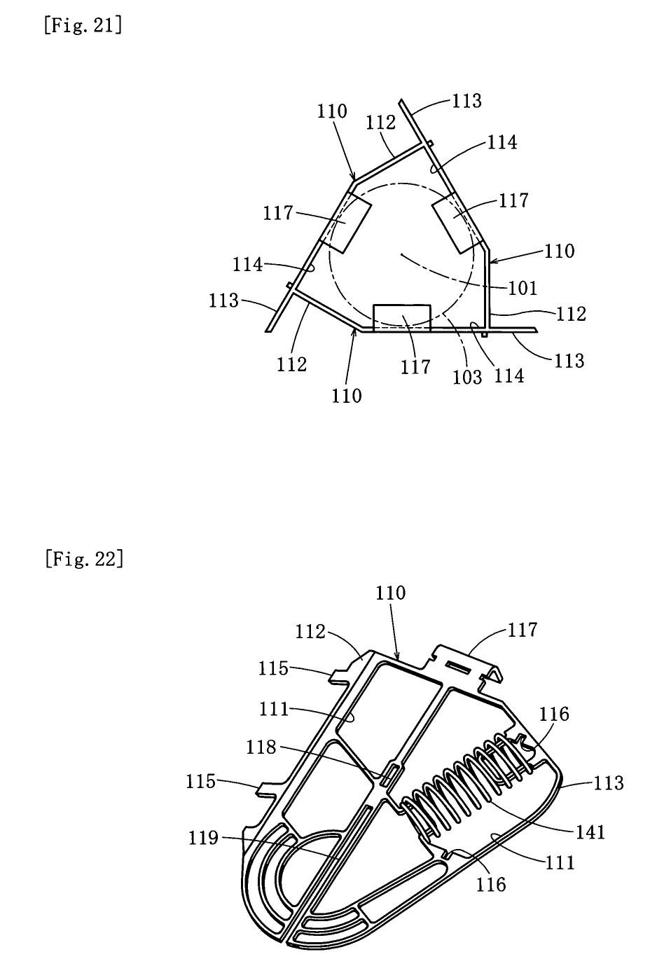

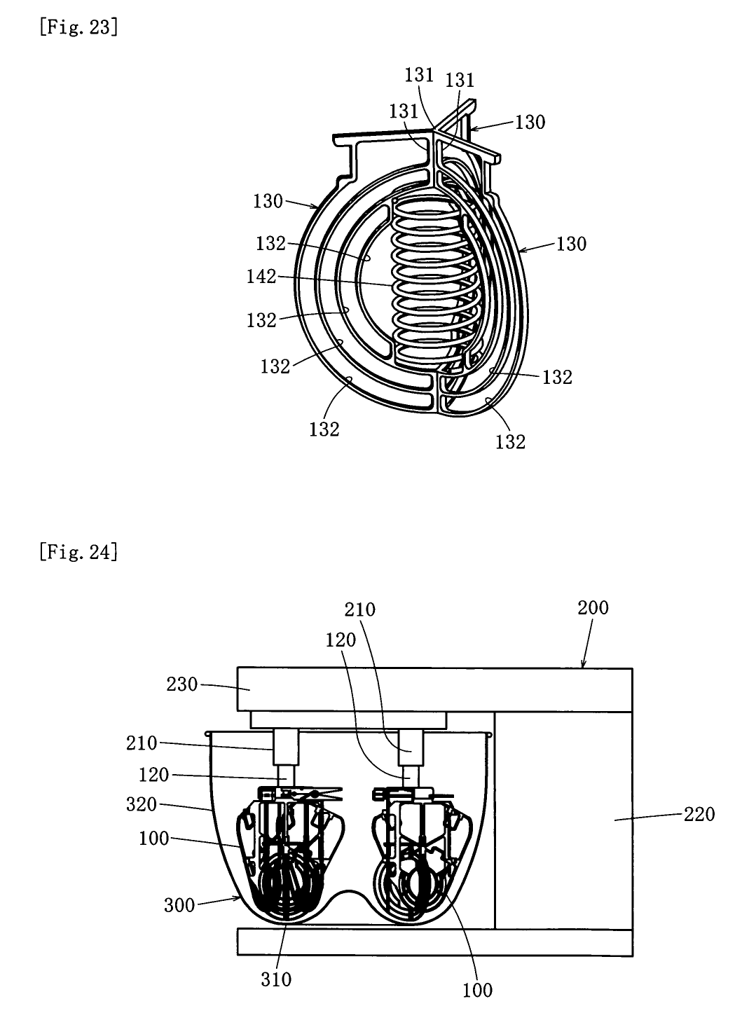

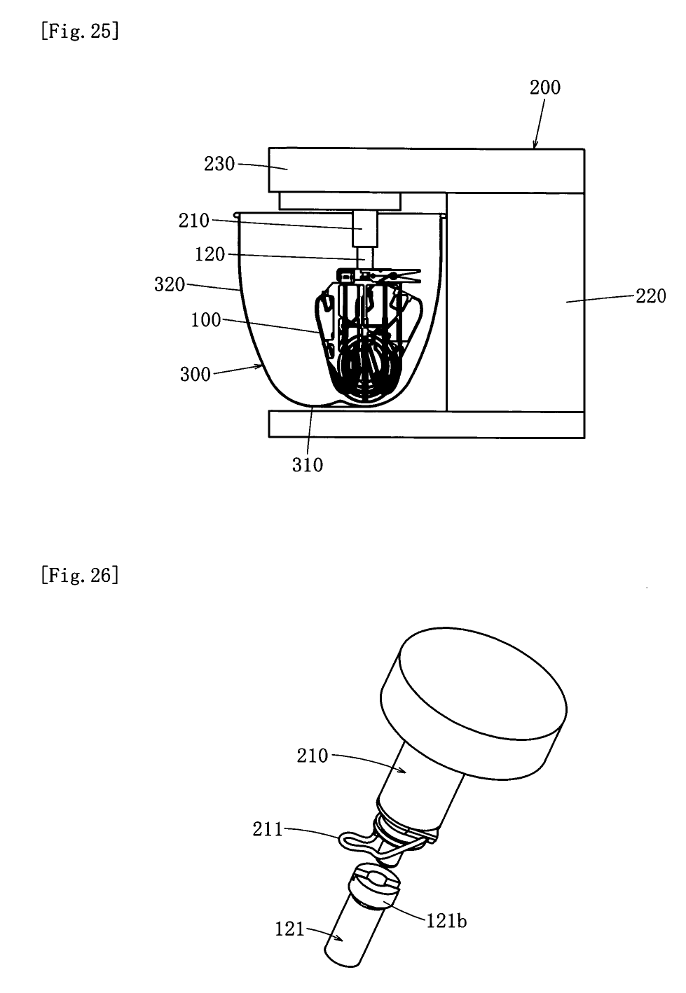

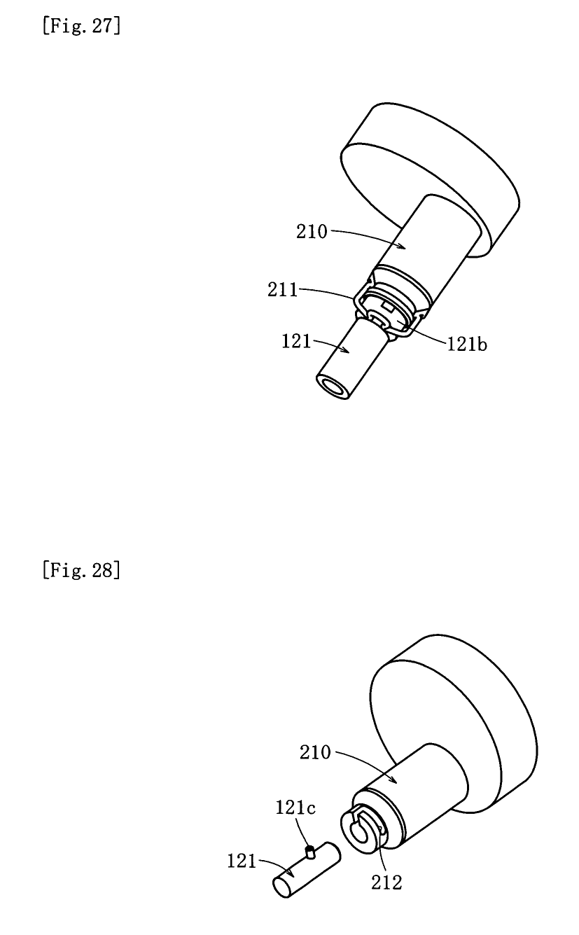

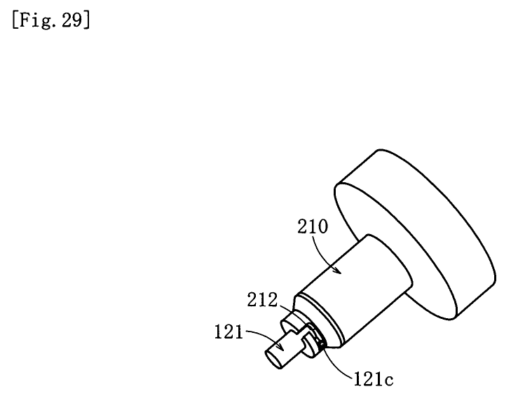

### BRIEF DESCRIPTION OF DRAWINGS

[FIG. 1] It is a perspective view illustrating the agitator of a first embodiment.

[FIG. 2] It is a front view illustrating the agitator of the first embodiment.

[FIG. 3] It is a side view illustrating the agitator of the first embodiment.

[FIG. 4] It is a plan view illustrating the agitator of the first embodiment.

[FIG. 5] It is an exploded perspective view illustrating the agitator of the first embodiment.

[FIG. 6] It is a perspective view illustrating the agitator of the first embodiment with a connecting member removed.

[FIG. 7] It is a front view illustrating the agitator of the first embodiment with the connecting member removed.

[FIG. 8] It is a side view illustrating the agitator of the first embodiment with the connecting member removed.

[FIG. 9] It is a plan view illustrating the agitator of the first embodiment with the connecting member removed.

[FIG. 10] It is a perspective view illustrating an agitating device with agitator on which the agitator of the first embodiment is mounted.

[FIG. 11] It is a side view illustrating the agitating device with agitator of the first embodiment with only the vessel sectioned. The agitating device is simplified.

[FIG. 12] It is a plan view illustrating the state of rotation of the agitator of the first embodiment in a vessel in relation to the vessel. Illustration of the connecting member is omitted.

[FIG. 13] It is a perspective view illustrating the agitator of a second embodiment with a connecting member removed.

[FIG. 14] It is a front view illustrating the agitator of the second embodiment with the connecting member removed.

[FIG. 15] It is a side view illustrating the agitator of the second embodiment with the connecting member removed.

[FIG. 16] It is a plan view illustrating the agitator of the second embodiment with the connecting member removed.

[FIG. 17] It is a side view illustrating an agitating device with the agitator of the second embodiment with only the vessel sectioned. The agitating device is simplified.

[FIG. 18] It is a perspective view of the agitator of a third embodiment with a connecting member removed.

[FIG. 19] It is a front view of the agitator of the third embodiment with the connecting member removed.

[FIG. 20] It is a side view of the agitator of the third embodiment with the connecting member removed.

[FIG. 21] It is a plan view of the agitator of the third embodiment with the connecting member removed.

[FIG. 22] It is a perspective view illustrating biased agitating blades of the agitator of a fourth embodiment.

[FIG. 23] It is a perspective view illustrating radial agitating blades of the agitator of a fifth embodiment.

[FIG. 24] It is a side view illustrating an agitating device with the agitator of a sixth embodiment with only a vessel sectioned. The agitating device is simplified.

[FIG. 25] It is a side view of a modification of the agitating device with the agitator of the first embodiment with only the vessel sectioned. The agitating device is simplified.

[FIG. 26] It is a perspective view illustrating a connecting construction between a connecting member and a supporting member of the agitator of a seventh embodiment. The connecting member and the supporting member are separated from each other.

[FIG. 27] It is a perspective view illustrating the connecting construction between the connecting member and the supporting member of the agitator of the seventh embodiment. The connecting member and the supporting member are connected to each other.

[FIG. 28] It is a perspective view illustrating a connecting construction between a connecting member and a supporting member of the agitator of an eighth embodiment. The connecting member and the supporting member are separated from each other.

[FIG. 29] It is a perspective view illustrating the connecting construction between the connecting member and the supporting member of the agitator of the eighth embodiment. The connecting member and the supporting member are connected to each other.

### EXPLANATION OF LETTERS PR NUMBERALS

100 agitator
101 central axis
102 virtual sphere
103 circumferential face of a virtual cylinder
110 biased agitating blade
111 window
112 one end in the circumferential direction of the central axis
113 the other end in the circumferential direction of the central axis
114 inner face
120 connecting member
130 radial agitating blade
131 end edge
132 window
141 coil spring
142 coil spring
200 agitating device
210 supporting member
300 vessel
310 bottom
320 circumferential wall BEST MODE FOR CARRYING OUT THE INVENTION

In the following, some embodiments of the present invention will be described. FIG. 1 through FIG. 5 illustrate the agitator 100 of a first embodiment of the present invention. FIG. 10 illustrates an example of an agitating device 200 on which the agitator 100 is mounted. This agitator 100 is set within a vessel 300 having a bottom 310 and a circumferential wall 320 rising from the circumference of the bottom 310. The vessel 300 of the first embodiment is a round-bottom-type vessel 300 of which bottom 310 is formed into a semispherical form, but the present invention may be applied, as shown in FIG. 17, to a flat-bottom-type vessel of which bottom 310 is formed flat, and as shown in FIG. 25, to a W-bottom-type vessel of which bottom 310 is formed into a W form in vertical section and rounded. This agitator 100 is attachably and detachably mounted on a supporting member 210 extending downward on the agitating device 200. The agitator 100 makes rotation or revolution or rotation-revolution being a combination of rotation and revolution in relation to the vessel 300 due to the rotation of the supporting member 210 to agitate a material in the vessel 300. The agitating device 200 comprises, for example, a pillar 220 and a head 230 protruding forward from an upper part of the pillar 220, and the pillar 220 supports the vessel 300 on the front side of the pillar 220 and has the agitator 100 set on the supporting member 210 extending downward from the head 230. In the case of this embodiment, the supporting member 210 is a rotary shaft which makes rotation or revolution or rotation-revolution. The supporting member 210 is rotated by a rotary driving mechanism, for example, a motor or the like set in the agitating device 200. A material in the vessel 300 is food, chemical or the like, and as an example, a mode of agitating a food such as egg, butter, cream, etc. with the agitator 100 to foam it may be indicated. Moreover, the present invention includes an embodiment wherein due to rotation of the vessel the agitator makes rotation or revolution or rotation-revolution in relation to the vessel to agitate a material in the vessel, and an embodiment wherein due to rotation of both the supporting member and the vessel the agitator makes rotation or revolution or rotation-revolution in relation to the vessel to agitate a material in the vessel.

The agitator according to the present invention is provided with at least three biased agitating blades which contact a virtual sphere centered on a virtual central axis extending vertically and surround the central axis. In the case of the agitator 100 of the first embodiment, as shown in FIG. 1 through FIG. 5, the agitator 100 is provided with three biased agitating blades 110 which contact a circumferential face 103 of a virtual cylinder of which central axis is coincident with a virtual central axis 101 extending vertically and surround the central axis 101. The biased agitating blades 110 are formed in plate forms. The biased agitating blades 110 may be four or more and arranged in a similar manner. In this embodiment, as identical biased agitating blades 110 are combined together, the agitator exhibits excellent handling in disassembling and assembling, but it is not necessary to use biased agitating blades of an identical form.

Each biased agitating blade 110 is provided with a penetrating window 111. The size, number or layout of the window is not limited in any way by the drawings or the like of the embodiment. The window may be one having a small area, which might be called a hole rather than a window. The window may be one having a large area that makes window frames narrow or thin. If the edges of the window frames are formed sharp, the material will be subjected to greater shearing forces when it passes the window 111 and the agitating will be enhanced, and moreover, foaming will be enhanced by air mixing. On the other hand, if the edges of the window frames are rounded, the foaming due to air mixing will be suppressed.

An end 112 of each biased agitating blade 110 on one side of the circumferential direction of the central axis 101 rests on an inner face 114 facing the central axis 101 of an adjoining biased agitating blade 110 on one side of the circumferential direction of the central axis 101. An end 113 of each biased agitating blade 110 is arranged to protrude on the other side of the circumferential direction of the central axis 101 in a direction to back away from the central axis 101 more than a biased agitating blade 110 adjoining on the other side of the circumferential direction of the central axis 101.

The adjoining biased agitating blades are separably connected by a fitting-into construction or a locking construction. In the case of this embodiment, a convex part 115, which comprises a protruding part or a protrusion protruding toward substantially one side of the circumferential direction of the central axis 101, is provided to an end 112 of each biased agitating blade 110 on one side in the circumferential direction of the central axis 101. On the other hand, a concave part 116, which comprises a groove or a hole or the like, is provided on an end 113 of each biased agitating blade 110 on the other side of the circumferential direction of the central axis 101, and the convex part 115 of the adjoining biased agitating blade 110 is inserted into and locked to the convex part 116 to separably connect the adjoining biased agitating blades 110. The fitting-into construction or the locking construction, which is provided on adjoining biased agitating blades, may take various forms. For example, one end may be provided with a concave part and the other end may be provided with a convex part. When biased agitating blades are designed as described in this embodiment, it is easy to assemble or disassemble the biased agitating blades. However, it is sufficient to just connect adjoining agitating blades separably, and for example, they may be connected by bolting.

As shown in FIG. 1 through FIG. 5, in this embodiment, the agitator is provided with a connecting member 120, which is attachably and detachably mounted on a supporting member 210 of the agitating device 200, and the biased agitating blades 110 are separably connected to the connecting member 120 by a fitting-into construction or a locking construction. FIG. 6 through FIG. 9 illustrate the agitator 100 from which the connecting member 120 is separated. As shown in FIG. 1 through FIG. 5, the connecting member 120 comprises a body 121, a locking member 122 and a stopper 123. Either the body 121 or the supporting member 210 is provided with a male thread and the other is provided with a female thread, and the body 121 and the supporting member 210 are connected by putting them together and screwing one into the other, and the body 121 and the supporting member 210 are separated by unscrewing them. The body 121 is provided with supporting pieces 121a being equal in number to the biased agitating blades 110, said supporting pieces 121a being formed into plates having a thickness direction in the vertical direction and extending radially in the radial directions of the central axis 101. The top end of each supporting piece 121a is bent downward, and the part bent downward of one supporting piece 121a is provided with a slit penetrating in a radial direction of the central axis 101. On the other hand, the biased agitating blade 110 is provided, at the top end thereof, with a locking piece 17 of which top end bent inwards, and this locking piece 17 is provided with a slit penetrating in the thickness direction of the biased agitating blade 110. The locking member 122 is formed in a plate form or a rod form, its top end 122a being one end in the longitudinal direction is so formed that it can be inserted into said slit, locking parts 122b protruding on both sides in the width direction are provide on the other end side, and a U-shaped groove in plan view is formed in each locking part 122b. Accordingly, when the three biased agitating blades 110 are assembled in such a way that they contact a circumferential face 103 of a virtual cylinder and surround the central axis 101, the biased agitating blades 110 and the body 121 are arranged in such a way that the locking pieces 117 of the biased agitating blades 110 and the supporting pieces 121a of the body 121 overlap and the slits of the locking pieces 117 and the slits of the supporting pieces 121a overlap, and the top end 122a of the locking member 122 is inserted from the side of the central axis 101 into the slit of the locking piece 117 of the first biased agitating blade 110 and the slit of the supporting piece 121a, the groove of one locking part 122b of the locking member 122 will embrace and pinch the supporting piece 121a of the body 121 and the locking piece 117 of the second biased agitating blade 110, said locking piece 117 overlapping with said supporting piece 121a, to hold them, and the groove of the other locking part 122b of the locking member 122 will embrace and pinch the supporting piece 121a of the body 121 and the locking piece 117 of the third biased agitating blade 110, said supporting piece 121a overlapping with said locking piece 117, to hold them. The stopper 123 is provided by overlapping a pair of rod-shaped members and rotatably connecting their intermediate parts together, thus making a pair of one ends thereof pinching parts and a pair of the other ends thereof manipulating parts, and an elastic member is provided so that the pinching parts exhibit certain pinching forces. This stopper 123 prevents the locking member 122 from coming off from the slit by pinching with the pinching parts the top end 122a of the locking member 122 protruding out of the slit of the locking piece 117 of the first biased agitating blade 110 and the slit of the supporting piece 121a. If necessary, the stopper 123 may be connected to the body 121, and if necessary, the body 121 may be provided with a co-pinching member, which is to be pinched by the stopper 123 together with the top end 122a of the locking member 122. When the arrangement is made according to this embodiment, it will be easy to disassemble and reassemble the biased agitating blades and the connecting member, but it is satisfactory provided that the biased agitating blades are separably connected to the connecting member, for example, they may be connected by bolting.

Plate-type radial agitating blades 130 are provided in the lower part of the biased agitating blades 110. The radial agitating blades 130 have end edges 131 substantially aligning with the central axis 101, extend in radial directions of the central axis 101 and are provided with penetrating windows 132. The radial agitating blades 130 are separably connected to the biased agitating blades 110. In other words, each biased agitating blade 110 is provided with a hole 118 and a groove 119 extending vertically, and the radial agitating blades 130 are separably connected to the adjoining biased agitating blades 110 by inserting and locking the top ends of the radial agitating blades 130 into the holes 118 and the grooves 119. The fitting-into construction or the locking construction of the radial agitating blades into or onto the biased agitating blades may take various forms. For example, the radial agitating blades may be provided with concave parts such as holes or grooves, and convex parts of the biased agitating blades may be fitted and locked in the concave parts. The radial agitating blades 130 may be set as described above in such a way that at least a part of the radial agitating blades 130 is contained in a lower part of the biased agitating blades 110, but the radial agitating blades 130 may be set on the lower side of the biased agitating blades 110. The number of the biased agitating blades 110 is discretionary and any number of blades may be used. If the edges of the window frames are formed sharp, the material passing the windows 132 will be subjected to stronger shearing forces and in turn the agitating will be promoted, and foaming due to air mixing will be promoted as well. Conversely, if the edges of the window frames are rounded, foaming due to air mixing will be suppressed. When the arrangement is done according to this embodiment, it is easy to disassemble and reassemble the biased agitating blades and the radial agitating blades, however, it is sufficient that the radial agitating blades are separably connected to the biased agitating blades, and for example, they may be connected by bolting.

The spacing between the frames of each window 111 of the biased agitating blades 110 is greater than the spacing between the frames of each window 132 of the radial agitating blades 130.

As the agitator 100 of the first embodiment is comprised of the biased agitating blades 110, and the adjoining biased agitating blades 110 are separably connected to each other, the agitator 100 can be disassembled after every use and the respective components thereof can be washed and dried and then reassembled, and these operations are easy. And, for example, when a food is to be agitated, the use of this agitator 100 prevents growth of bacteria in the food and contamination of the food by foreign matter, thus the safety of the food is secured. Moreover, for example, when a chemical is to be agitated, the use of this agitator 100 prevents degeneration of the chemical and contamination thereof by foreign matter, thus the stability of the quality of the chemical is secured.

At least three biased agitating blades 110 are provided to contact the virtual sphere 102 and surround the central axis 101, each biased agitating blade 110 is provided with the penetrating window 111, and each biased agitating blade 110 is arranged in such a way that an end 112 of each biased agitating blade 110 on one side of the circumferential direction of the central axis 101 rests on an inner face 114 facing the central axis 101 of an adjoining biased agitating blade 110 on one side of the circumferential direction of the central axis 101, and that an end 113 of each biased agitating blade 110 on the other side of the circumferential direction of the central axis 101 protrudes in a direction to back away from the central axis 101 more than an adjoining biased agitating blade 110 on the other side in the circumferential direction of the central axis 101. Accordingly, the entrained rotation of the material is effectively prevented. The causes of this are estimated that as each biased agitating blade 110 does not extend in any radial directions of the central axis 101 but extends off the central axis 101 to surround the central axis 101, the flows of the material in the circumferential direction of the central axis 101 are divided into flows of the material along the biased agitating blades 110 and flows of the material passing through the windows 111 of the biased agitating blades 110, which results in complex flows of the material, and that the end 113 of each biased agitating blade 110 protruding from an adjoining biased agitating blade 110 induces disturbances in the flows of the material (Refer to FIG. 12. The outline arrows indicate the flows of the material when the agitator 100 rotates clockwise in relation to the vessel 300). Moreover, when the material passes through the window 111 of each biased agitating blade 110, the material is subjected to shearing forces and in turn agitating is enhanced and foaming due to air mixing is enhanced as well.

The biased agitating blades of the present invention are arranged in such a way that they contact a virtual sphere centering on a virtual axis extending vertically. Among them, the biased agitating blades of the above-mentioned embodiment contact a circumferential face 103 of a virtual cylinder of which central axis is coincident with a virtual central axis 101 extending vertically. With this arrangement, the circulation of the material in the vertical direction is suppressed and the design and the production of the biased agitating blades are relatively easy.

The agitator of the present invention includes an embodiment wherein biased agitating blades are directly and separably connected to a supporting member. For example, an agitator 100 may be constructed in a form of the agitator 100 of the first embodiment from which the connecting member 120 is removed (a form as illustrated in FIG. 6), and the locking pieces 117 of the biased agitating blades 110 of the agitator 100 may be clamped by a band on the outer circumferential side, and this clamping force may be used to hold the supporting member 210 by the locking pieces 117. In contrast to it, the agitator 100 of said embodiment is provided with the connecting member 120 which is detachably and attachably mounted on the supporting member 210 of the agitating device 200, and the biased agitating blades 110 are separably connected to the connecting member 120. With this arrangement, as the biased agitating blades 110 are held by the connecting member 120 as well, the mounting strength of the biased agitating blades 110 is enhanced.

The agitator of the present invention includes an embodiment wherein only biased agitating blades are provided as agitating blades. In contrast to it, the agitator 100 of said embodiment is provided, in the lower part of the biased agitating blades 110, with plate-type radial agitating blades 130, of which end edges 131 are substantially aligned with the central axis 101 and which extend in radial directions of the central axis 101 and are provided with penetrating windows 132, and the radial agitating blades 130 are separably connected to the biased agitating blades 110. With this arrangement, when a round-bottom-type vessel 300 having a hemisherically formed bottom 310 is used as is the case of the embodiment, and when a vessel of which horizontal section is reduced in its lower part is used, the material present in a position that can not be agitated by the biased agitating blades 110 is reliably agitated by the radial agitating blades 130 (refer to FIG. 10 and FIG. 11).

The agitator of the present invention does not require relationship between the configuration of the windows of the biased agitating blades and the configuration of the windows of the radial agitating blades. In contrast to it, in the agitator 100 of said embodiment, the spacing between the frames of each window 111 of the biased agitating blades 110 is greater than the spacing between the frames of each window 132 of the radial agitating blades 130. With this arrangement, when the material foaming due to air mixing rises, the probability of collapsing this foaming is lower. Here, the explanation was given in terms of the frame spacing, but the areas of the windows of the biased agitating blades may be made larger than the areas of the windows of the radial agitating blades. Or, the frame spacing of the windows or the areas of the windows may be enlarged gradually from the lower part to the higher part. This may be applied to only the windows of the biased agitating blades, or only the windows of the radial agitating blades, or all of the windows of the biased agitating blades and the windows of the radial agitating blades.

Next, some other embodiments will be described. Members and parts exhibiting like basic functions to those of the members and parts of the agitator 100 of the first embodiment will be given like letters or numerals and their descriptions will be omitted, and only members and parts of which constructions differ from those of the members and parts of the agitator 100 of the first embodiment will be described. FIG. 13 through FIG. 17 illustrate a second embodiment. In these drawings, the connecting member 120 is not illustrated. The biased agitating blades 110 of the first embodiment contact the circumferential face 103 of a virtual cylinder of which central axis is coincident with a virtual central axis 101 extending vertically, but the biased agitating blades 110 of the second embodiment contact a virtual sphere 102 centering on a virtual central line 101 extending vertically. Accordingly, whereas the biased agitating blades 110 of the first embodiment face substantially in horizontal directions, the biased agitating blades 110 of the second embodiment have a degree of freedom in their directions, and in the case of the drawings, the outer faces of the biased agitating blades 110 face downward slightly. With this arrangement, the circulation of the material in the vertical direction is enhanced. In the first embodiment, the round-bottom-type vessel 300 having a hemispherically formed bottom 310 is used, but in the second embodiment, as shown in FIG. 17, a flat-bottom-type vessel of which bottom 310 is formed flat is used. Accordingly, the radial agitating blades 130, which are provided in the agitator 100 of the first embodiment, are not provided in the second embodiment. Except these differences, the agitator 100 of the second embodiment exhibits working and effect similar to those of the agitator 100 of the first embodiment. As to the biased agitating blades 110, four or more blades may be used in a similar arrangement.

FIG. 18 through FIG. 21 illustrate a third embodiment. In these drawings, the connecting member 120 is not illustrated. The biased agitating blades 110 of the first embodiment are substantially flat without any bend, whereas the biased agitating blades 110 of the third embodiment bend in such a way that their intermediate parts in the circumferential direction of the central axis 101 protrude outward. With this arrangement, the amount of protrusion of the end 113 of a biased agitating blade 110 protruding from an adjoining biased agitating blade 110 is increased. Moreover, in the first embodiment, a round-bottom-type vessel 300 having a hemispherically formed bottom 310 is used, whereas in the third embodiment, a flat-bottom-type vessel having a flatly formed bottom 310 is used. Accordingly, in the third embodiment, radial agitating blades 130, which are provided on the agitator 100 of the first embodiment, are not provided. Except these differences, the agitator 100 of the third embodiment exhibits working and effect similar to those of the agitator 100 of the first embodiment.

FIG. 22 illustrates a biased agitating blade 110 of an agitator 100 of a fourth embodiment. This biased agitating blade 110 is provided with a coil spring 141 that is mounted compressively between frames of a window 111. The coil spring 141 is arranged in such a way that its coiling axis is substantially in the plane of the biased agitating blade 110.

FIG. 23 illustrates radial agitating blades 130 of an agitator 100 of a fifth embodiment. These radial agitating blades 130 are provided with a coil spring 142 that is mounted compressively between frames of windows 132. The coil spring 142 is arranged in such a way that the coiling axis of the coil is substantially in the planes of the radial agitating blades 130.

If a coil spring 141 or 142 is compressively mounted between frames of the window 111 or windows 132 of at least one of the biased agitating blades 110 and the radial agitating blades 130, like the agitator 100 of the fourth embodiment and the agitator 100 of the fifth embodiment, the material is subjected to shearing forces when the material passes through the coil spring 141 or the coil spring 142 and the agitating is promoted, and moreover, foaming due to air mixing is promoted. The coil spring 141 or 142 can be easily mounted in or dismounted from the window 111 or windows 132 by compressing it, and the degree of foaming can be adjusted by mounting or dismounting it. Furthermore, the working of the coil spring 141 or 142 is adjusted by changing the diameter, pitch, etc. of the wire of the coil spring 141 or 142. Except these differences, the agitators 100 of the fourth embodiment and the fifth embodiment exhibit working and effect similar to those of the agitator 100 of the first embodiment.

FIG. 24 illustrates a sixth embodiment. The agitating device 200 of the first embodiment is provided with a single supporting member 210, and a single agitator 100 is separably mounted on this supporting member 210, whereas the agitating device 200 of the sixth embodiment is provided with a plurality of supporting members 210 on which agitators 100 are separably mounted. To be more precise, the agitating device with agitators of the sixth embodiment comprises an agitating device 200 having a plurality of supporting members 210 extending downward, said supporting members 210 having their rotation axes or revolution axes kept substantially parallel, a vessel 300 having a bottom 310 and a circumferential wall 320 rising from the circumference of the bottom 310, said vessel being mounted on the agitating device 200, and a plurality of agitators 100 being attachably and detachably mounted respectively on the supporting members 210 of the agitating device 200, and the agitating device with agitators is so constructed that the agitators 100 are made to rotate and/or revolve in relation to the vessel 300 due to rotation of at least either the supporting members 210 or the vessel 300 so as to agitate a material in the vessel 300. This provides a multi-axial agitating device with agitators, which exhibit the effect obtained by the agitator 100 of the present invention. Except these differences, the agitators 100 of the sixth embodiment exhibit working and effect similar to those of the agitator 100 of the first embodiment.

FIG. 26 illustrates a seventh embodiment wherein the connecting construction between the connecting member 120 of the agitator 100 and the supporting member 210 differs from that of the first embodiment. As to the connecting member 120, only the shaft portion of the body 121 is illustrated, and the supporting piece 121a is not illustrated. In the first embodiment, of the body 121 of the connecting member 120 and the supporting member 210, one is provided with a male thread and the other is provided with a female thread, and they are put together and screwed to each other to connect the body 121 and the supporting member 210, and they are unscrewed to separate the body 121 from the supporting member 210. In the case of the seventh embodiment, the end of either the body 121 of the connecting member 120 or the supporting member 210 is formed into a tube and the end of the other is formed into a bar to be inserted into the tube, the top end of the former is provided with a flange 121b extending in the radial directions of the central axis and the latter is provided with a U-shaped connecting member 211 set swingably around both ends thereof, and when the body 121 of the connecting member 120 and supporting member 210 are fitted together and the connecting member 211 is swung to hook on the flange 121b, the body 121 and the supporting member 210 are connected to each other (refer to FIG. 27), and when the connecting member 210 is swung reversely to detach it from the flange 121b, the body 121 and the supporting member 210 are separated from each other (refer to FIG. 26). Except these differences, the agitator 100 of the seventh embodiment exhibits working and effect similar to those of the agitator 100 of the first embodiment.

FIG. 28 illustrates an eighth embodiment wherein the connecting construction between the connecting member 120 of the agitator 100 and the supporting member 210 differs from that of the first embodiment. Of the connecting member 120, only the shaft part of the body 121 is illustrated, and the supporting pieces 121a are not illustrated. In the case of the eighth embodiment, the end of either the body 121 of the connecting member 120 or the supporting member 210 is formed into a tube and the end of the other is formed into a bar to be inserted into the tube, the end of the bar is provided with a protrusion 121c on its circumferential face, the end of the tube is provided with a groove 212 for receiving the protrusion 121c when the end of the bar is inserted, the groove 212 extends in the axial direction of the central axis and bends to the circumferential direction, forming an L-shape, and after the end of the tube is inserted, the tube is turned in the circumferential direction of the central axis to guide the protrusion 121c to the top end in the circumferential direction of the groove 212 so as to prevent both ends from coming off, and by this the body 121 and the supporting member 210 are connected to each other. When the reverse operation is done, the body 121 and the supporting member 210 are separated from each other. Except these differences, the agitator 100 of the eighth embodiment exhibits working and effect similar to those of the agitator 100 of the first embodiment.

The present invention includes an embodiment wherein a scraper for scraping the material sticking to the vessel bottom 310 is provided on the lower end of the agitator. Now, with the description of all the embodiments described so far, has been disclosed fully the agitating device with agitator, which comprises an agitating device having a supporting member extending downward, a vessel having a bottom and a circumferential wall rising from the circumference of the bottom, said vessel being mounted on the agitating device, and the agitator of the present invention being attachably and detachably mounted on the supporting member of the agitating device, wherein the agitator is made to rotate and/or revolve in relation to the vessel due to rotation of at least either the supporting member or the vessel so as to agitate a material in the vessel.

1-8. (canceled)

9. An agitator which is set within a vessel having a bottom and a circumferential wall rising from the circumference of the bottom, is attachably and detachably mounted on a supporting member extending downward on an agitating device, makes rotation and/or revolution in relation to the vessel due to rotation of at least either the supporting member or the vessel to agitate a material in the vessel, said agitator comprising
at least three biased agitating blades arranged to contact a virtual sphere or a virtual circumferential face of a virtual cylinder, wherein the virtual sphere is centered on and surrounds, or the virtual cylinder extends axially on and surrounds, a vertically extending virtual central axis,
each of said biased agitating blades being provided with a penetrating window,
one end in the circumferential direction of the central axis of each of said biased agitating blade resting on an inner face facing the central axis of an adjoining biased agitating blade on said one side in the circumferential direction of the central axis, the other end thereof in the circumferential direction of the central axis protruding to back away from the central axis than an adjoining agitating blade on the other side in the circumferential direction of the central axis, and
the adjoining agitating blades being separably connected to each other.

10. The agitator according to claim 9, wherein the at least three biased agitating blades are arranged to contact the virtual sphere.

11. The agitator according to claim 9, wherein the at least three biased agitating blades are arranged to contact the virtual circumferential face of the virtual cylinder.

12. The agitator according to claim 9, wherein the agitator is provided with a connecting member, which is detachably and attachably mounted on the supporting member of the agitating device, and the biased agitating blades are separably connected to the connecting member.

13. The agitator according to claim 9, wherein the agitator is provided, in the lower part or on the lower side thereof, with plate-type radial agitating blades, of which end edges are substantially aligned with the central axis and which extend in radial directions of the central axis and are provided with penetrating windows, and the radial agitating blades are separably connected to the biased agitating blades.

14. The agitator according to claim 13, wherein the spacing between the frames of each window of the biased agitating blades is greater than the spacing between the frames of each window of the radial agitating blades.

15. The agitator according to claim 13, wherein the agitator is provided, on at least either the biased agitating blades or the radial agitating blades, with a coil spring compressively mounted between window frames.

16. The agitator according to claim 9, wherein the agitator is provided, on the biased agitating blades, with a coil spring compressively mounted between window frames.

17. A combination of the agitator according to claim 9 and an agitating device, comprising
the agitating device having a supporting member extending downward,
a vessel having a bottom and a circumferential wall rising from the circumference of the bottom, said vessel being mounted on the agitating device, and
the agitator being attachably and detachably mounted on the supporting member of the agitating device,
wherein the agitator is adapted to rotate and/or revolve in relation to the vessel due to rotation of at least either the supporting member or the vessel so as to agitate a material in the vessel.

18. A combination of a plurality of the agitators according to claim 9 and an agitating device, comprising
the agitating device having a plurality of supporting members extending downward, said supporting members having their rotation axes or revolution axes kept substantially parallel,
a vessel having a bottom and a circumferential wall rising from the circumference of the bottom, said vessel being mounted on the agitating device, and
the plurality of agitators being attachably and detachably mounted respectively on the supporting members of the agitating device,
wherein the agitators are adapted to rotate and/or revolve in relation to the vessel due to rotation of at least either the supporting members or the vessel so as to agitate a material in the vessel.
